(19) United States
(12) Patent Application Publication
(10) Pub. No.: US 2012/0132029 A1
(43) Pub. Date: May 31, 2012

(54) Bicycle pedal

(75) Inventor: Yung-Ji Hung, Taichung City (TW)

(73) Assignee: Mandai Aluminum Co., Ltd.

(21) Appl. No.: 12/930,660

(22) Filed: Jan. 13, 2011

(30) Foreign Application Priority Data
Nov. 26, 2010 (TW) 099222990

(51) Int. Cl. B62M 3/08

(52) U.S. Cl. 74/594.4

(57) ABSTRACT

A bicycle pedal has a connecting device and two arcuate bodies. Each body has an opening, a central section, a first end section and a second end section. The central sections are securely mounted on the connecting device. Each first end section is mounted through and protrudes out from the opening of the other body. Because the bodies are arcuate, the structural strength of the bicycle pedal is excellent and the bent bodies can provide a cushion effect to distribute evenly the pedaling force.

### BACKGROUND OF THE INVENTION

1. Field of the Invention

The present invention relates to a bicycle pedal, and more particularly to a bicycle pedal with an enhanced structural strength.

2. Description of Related Art

A conventional bicycle pedal has a spindle, a bracket and two bodies. The bracket is rotatably mounted around the spindle. The bodies are respectively and securely mounted on two opposite sides of the bracket by bolts.

However, the bodies do not have any cushion effect, so a pedaling force will be concentrated on the bolts and on where the bodies are connected with the bracket such that the bodies are easily broken and fall off the bracket. Therefore, the structural strength of the conventional bicycle pedal needs to be enhanced.

Because the structural strength of the conventional bicycle pedal is insufficient, lots of bolts are needed to strengthen the connection between the bodies and the bracket. Consequently, the processing cost of the screwed holes of the bracket and the assembling time are hard to be reduced.

To overcome the shortcomings, the present invention tends to provide a bicycle pedal to mitigate the aforementioned problems.

### SUMMARY OF THE INVENTION

The main objective of the invention is to provide a bicycle pedal with an enhanced structural strength.

A bicycle pedal has a connecting device and two arcuate bodies. Each body has an opening, a central section, a first end section and a second end section. The central sections are securely mounted on the connecting device. Each first end section is mounted through and protrudes out from the opening of the other body. Because the bodies are arcuate, the structural strength of the bicycle pedal is excellent and the bent bodies can provide a cushion effect to distribute evenly the pedaling force.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a bicycle pedal in accordance with the present invention;

FIG. 2 is a partially exploded perspective view of the bicycle pedal in FIG. 1;

FIG. 3 is an enlarged top view of the bicycle pedal in FIG. 1;

FIG. 4 is an enlarged side view of the bicycle pedal in FIG. 1;

FIG. 5 is an enlarged side view in partial section of the bicycle pedal in FIG. 4; and

FIG. 6 is an enlarged side view in partial section of a second embodiment of the bicycle pedal in accordance with the present invention.

### DETAILED DESCRIPTION OF PREFERRED EMBODIMENT

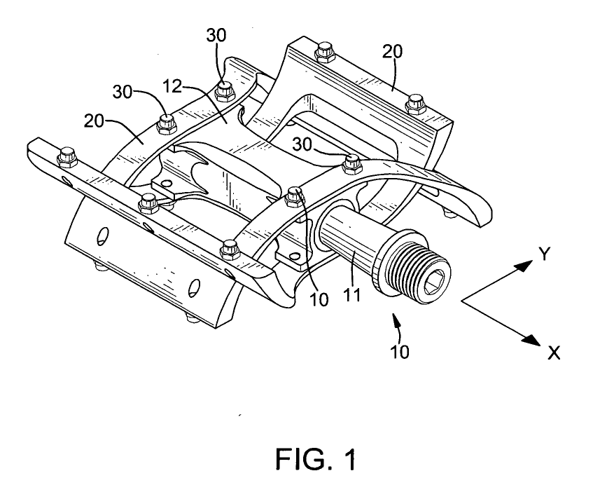

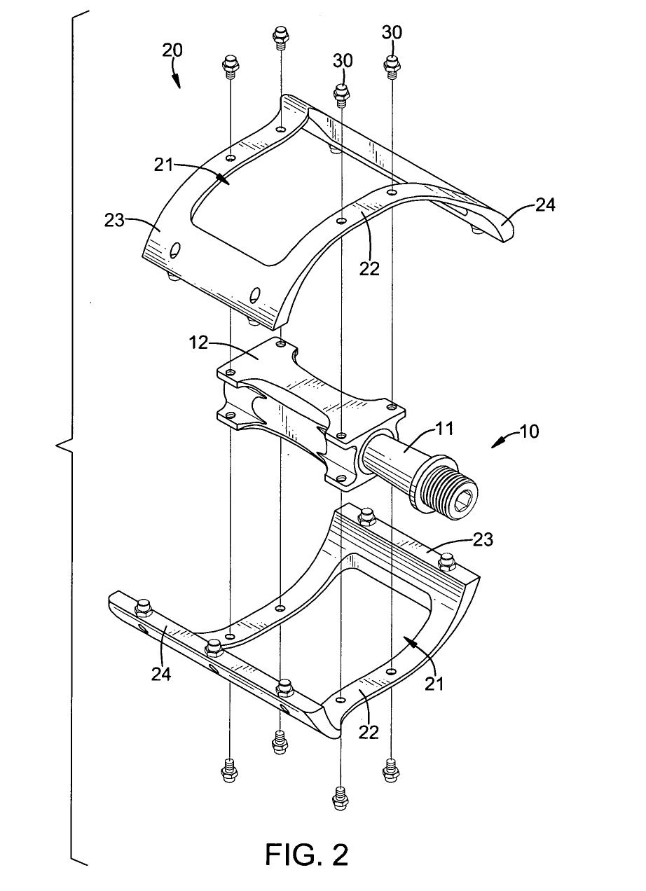

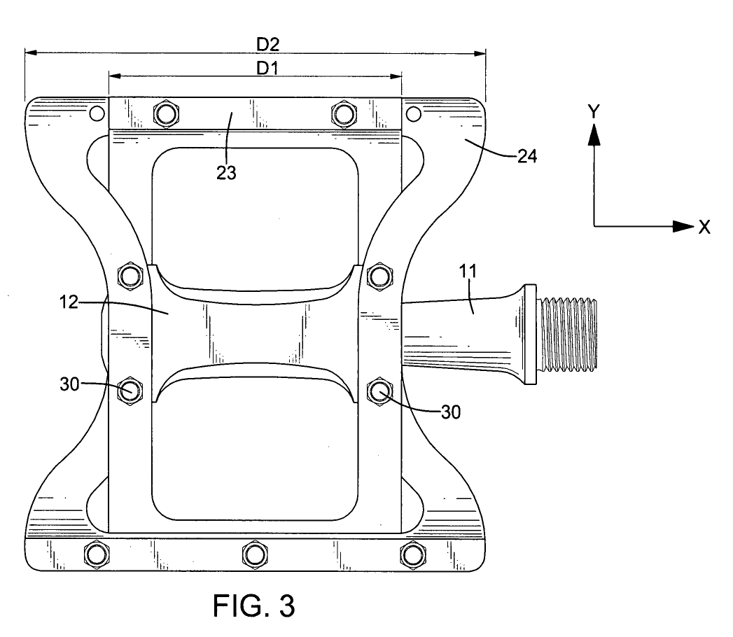

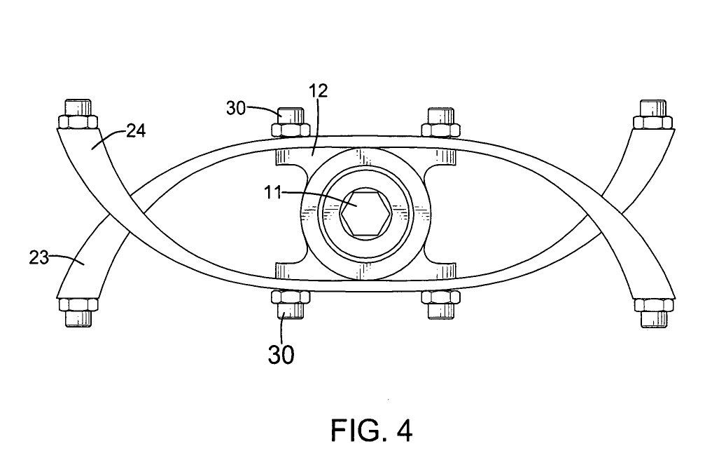

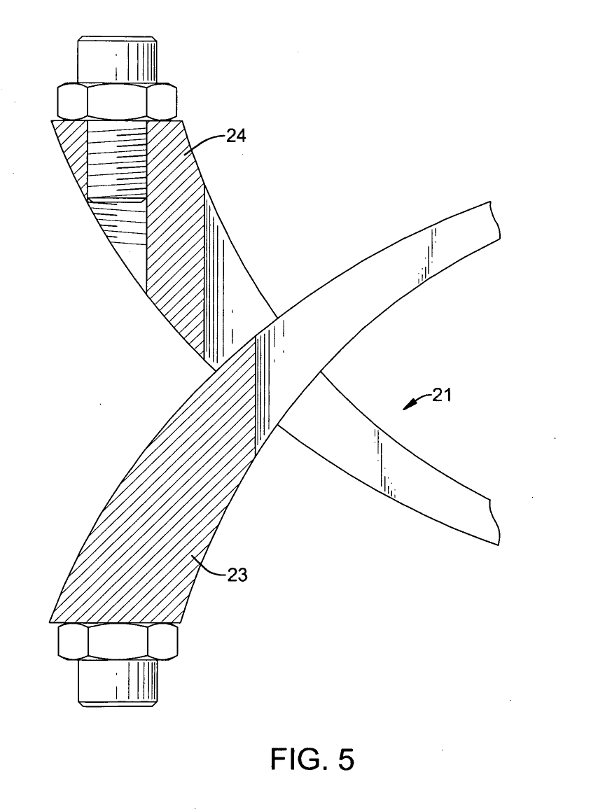

With reference to FIGS. 1 to 5, a first embodiment of a bicycle pedal in accordance with the present invention comprises a connecting device 10 and two bodies 20.

The connecting device 10 has a spindle 11 and a bracket 12. The bracket 12 is rotatably mounted around the spindle 11 and has two opposite outer surfaces. The connecting device 10 may be conventional and detailed description is omitted. An extending direction of the connecting device 10 is defined as an X axis. An extending direction of the bodies 20 is defined as a Y axis. The X axis is perpendicular to the Y axis and the X axis and the Y axis are located at the same plane.

The bodies 20 are hollow and arcuate and are respectively mounted securely on the bracket 12. Each body 20 has an opening 21, a central section 22, a first end section 23 and a second end section 24. The openings 21 are respectively formed through the bodies 20. The two central sections 22 are respectively mounted securely on the outer surfaces of the bracket 12. The first end section 23 of each body 20 is mounted through and protrudes out from the opening 21 of the other body 20. The second end sections 24 are respectively opposite to the first end sections 23. The central section 22 is located between the first end section 23 and the second end section 24 of the body 20. The first end section 23 and the second end section 24 of each body 20 are located on the Y axis.

Preferably, the first end section 23 has an extending length D1 parallel to the X axis, and the second end section 24 has an extending length D2 parallel to the X axis and longer than the extending length D1 of the first end section 23.

Preferably, a gap is formed between the first end section 23 of each body 20 and the second end section 24 of the other body 20. Accordingly, when the rider steps on one of the arcuate bodies 20, the arcuate body 20 is bent and the first end section 23 of the body 20 abuts the second end section 24 of the other body 20. Therefore, the bent arcuate body 20 can provide a cushion effect to distribute evenly the pedaling force. Moreover, the upper first end section 23 and the upper second end section 24 of the bent body 20 are respectively supported by the lower second end section 24 and the lower first end section 23 of the other body 20, such that the pedaling force is kept from being concentrated on a single one body 20.

Preferably, a size and a shape of each body 20 are the same as those of the other body 20. Accordingly, the rider can always step and pedal on the same pedaling area no matter which body 20 is on the top of the bicycle pedal. As long as the bodies 20 are arcuate to cushion the pedaling force, the present invention does not limit the size and the shape of the bodies 20.

Preferably, four bolts 30 are mounted through the central section 22 of each body 20 and screwed into the bracket 12. The structural strength of the bicycle pedal in accordance with the present invention is sufficient because of the arcuate bodies 20, so the number of bolts 30 connecting the bodies 20 with the bracket 12 can be reduced. Accordingly, the processing for forming screwed holes in the bracket 11 can be simplified since the number of the screwed holes is also reduced, and to assemble the bodies 20 with the bracket 12 is fast and convenient.

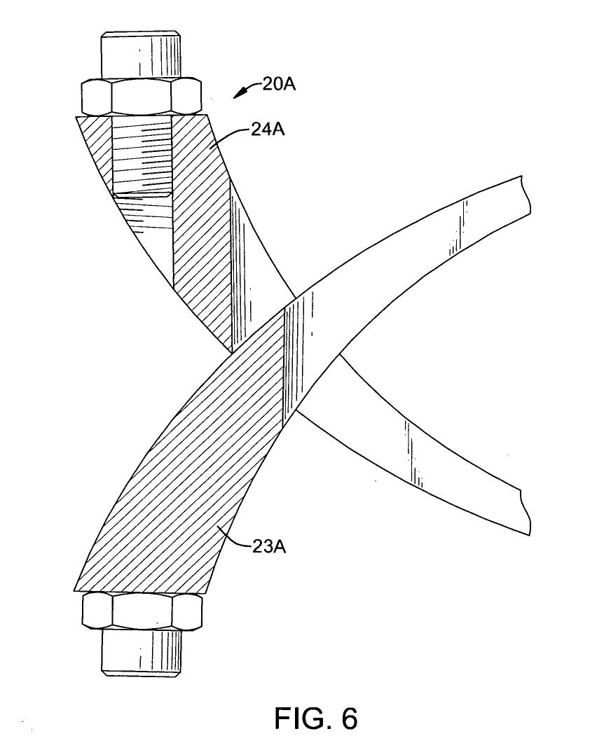

With reference to FIG. 6, a second embodiment of the bicycle pedal is substantially the same as the first embodiment, except that the first end section 23A of each body 20A abuts the second end section 24A of the other body 20A.

From the above description, it is noted that the present invention has the following advantages:

1. Enhanced Structural Strength:

Because the bodies 20,20A are arcuate, the structural strength of the bicycle pedal is excellent and the durability and life span of the bicycle pedal are prolonged.

2. Even Pedaling Force:

The pedaling force is kept from being concentrated on a single one body 20,20A because the bodies 20,20A are arcuate. Moreover, the bent first end section 23,23A and the bent second end section 24,24A of the body 20,20A are respectively supported by the other body 20,20A to distribute the pedaling force to the two bodies 20,20A.

3. Fast Assembling:

Because the structural strength of the bicycle pedal is sufficient, the number of bolts 30 can be reduced, the processing of forming screwed holes in the bracket 11 can be simplified since the number of the screwed holes is also reduced, and to assemble the bodies 20 with the bracket 12 is quick.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A bicycle pedal comprising:
a connecting device having
a spindle; and
a bracket rotatably mounted around the spindle and having two opposite outer surfaces; and
two hollow and arcuate bodies respectively mounted securely on the bracket, each body having
an opening formed through the body;
a central section, wherein the two central sections are respectively mounted securely on the outer surfaces of the bracket;
a first end section mounted through and protruding out from the opening of the other body; and
a second end section opposite to the first end section, wherein the central section is located between the first end section and the second end section.

2. The bicycle pedal as claimed in claim 1, wherein an extending direction of the connecting device is defined as an X axis; each first end section has an extending length parallel to the X axis; and each second end section has an extending length parallel to the X axis and longer than the extending length of each first end section.

3. The bicycle pedal as claimed in claim 1, wherein a gap is formed between the first end section of each body and the second end section of the other body.

4. The bicycle pedal as claimed in claim 2, wherein a gap is formed between the first end section of each body and the second end section of the other body.

5. The bicycle pedal as claimed in claim 1, wherein the first end section of each body abuts the second end section of the other body.

6. The bicycle pedal as claimed in claim 2, wherein the first end section of each body abuts the second end section of the other body.

7. The bicycle pedal as claimed in claim 4, wherein a size and a shape of each body are the same as those of the other body.

8. The bicycle pedal as claimed in claim 6, wherein a size and a shape of each body are the same as those of the other body.

9. The bicycle pedal as claimed in claim 7, wherein four bolts are mounted through the central section of each body and screwed into the bracket.

10. The bicycle pedal as claimed in claim 8, wherein four bolts are mounted through the central section of each body and screwed into the bracket.
